(19) United States
(12) Patent Application Publication
(10) Pub. No.: US 2023/0339498 A1
(43) Pub. Date: Oct. 26, 2023

(54) CONTROL DEVICE, CONTROL METHOD, AND COMPUTER-READABLE RECORDING MEDIUM

(71) Applicant: HONDA MOTOR CO., LTD., Tokyo (JP)

(72) Inventors: Jumpei NOGUCHI, Tokyo (JP); Gaku SHIMAMOTO, Tokyo (JP)

(73) Assignee: HONDA MOTOR CO., LTD., Tokyo (JP)

(21) Appl. No.: 18/113,168

(22) Filed: Feb. 23, 2023

(30) Foreign Application Priority Data
Mar. 22, 2022 (JP) 2022-045653

(51) Int. Cl. B60W 30/18; B60W 60/00; B60W 40/08; B60W 30/06

(52) U.S. Cl. CPC B60W 60/001; B60W 30/06; B60W 30/181; B60W 40/08; B60W 2720/10

(57) ABSTRACT

A control device of a moving object includes: a controller configured to control movement of a moving object based on a specific operation performed on a portable information terminal for a user of the moving object. The controller is configured to: when executing the movement control, perform first deceleration control on the moving object in response to interruption of the specific operation, and second deceleration control on the moving object in response to approaching a target movement position of the movement control, and set deceleration of the second deceleration control to be smaller than deceleration of the first deceleration control.

### CROSS-REFERENCE TO RELATED APPLICATIONS

This application is based on and claims priority under 35 USC 119 from Japanese Patent Application No. 2022-045653 filed on Mar. 22, 2022. the contents of which are incorporated herein by reference.

### TECHNICAL FIELD

The present disclosure relates to a control device, a control method, and a computer-readable recording medium.

### BACKGROUND ART

In recent years, efforts have been made to provide access to sustainable transport systems that are considerate of vulnerable people in transport participants. In order to realize the above-described object, attention is focused on research and development to further improve safety and convenience of traffic through research and development related to autonomous driving.

In the related art, there is known a remote parking system that remotely operates a vehicle to park in a designated predetermined parking space or to exit the parking space.

International Patent Publication No. WO2018/047222 pamphlet (hereinafter, referred to as Patent Literature 1) describes an exit assistance device capable of detecting a position of an operator who designates an exit position of a vehicle using an in-vehicle sensor and the like, setting an exit position in the vicinity of the detected operator, and remotely controlling the vehicle to autonomously exit to the exit position in the vicinity of the operator.

According to the exit assistance device described in Patent Literature 1, it is possible to cause the vehicle autonomously exit to the exit position in the vicinity of the operator. However, Patent Literature 1 does not describe, for example, how the vehicle moves while moving to the exit position, or how the vehicle moves when approaching the exit position in the vicinity of the operator. Therefore, in the autonomous driving, there is room for improvement regarding the movement of the vehicle when moving to the exit position and when approaching the exit position.

The present disclosure provides a control device, a control method, and a computer-readable recording medium storing a control program capable of appropriately decelerating a moving object according to a situation when the moving object performs autonomous exit. Further, the present disclosure contributes to development of sustainable transport systems.

### SUMMARY

A first aspect of the present disclosure relates to a control device of a moving object, the control device including:
a controller configured to control movement of a moving object based on a specific operation performed on a portable information terminal for a user of the moving object, in which
the controller is configured to:
   when executing the movement control, perform first deceleration control on the moving object in response to interruption of the specific operation, and second deceleration control on the moving object in response to approaching a target movement position of the movement control, and
   set deceleration of the second deceleration control to be smaller than deceleration of the first deceleration control.

A second aspect of the present disclosure relates to a control method performed by a controller, in which
the controller is configured to control movement of a moving object based on a specific operation performed on a portable information terminal for a user of the moving object, and
the control method includes:
   when executing the movement control, performing first deceleration control on the moving object in response to interruption of the specific operation, and second deceleration control on the moving object in response to approaching a target movement position of the movement control: and
   setting deceleration of the second deceleration control to be smaller than deceleration of the first deceleration control.

A third aspect of the present disclosure relates to a non-transitory computer-readable recording medium storing a control program for causing a processor to execute processing, in which
the processor is configured to control movement of a moving object based on a specific operation performed on a portable information terminal for a user of the moving object, and
the processing includes:
   when executing the movement control, performing first deceleration control on the moving object in response to interruption of the specific operation, and second deceleration control on the moving object in response to approaching a target movement position of the movement control, and
   setting deceleration of the second deceleration control to be smaller than deceleration of the first deceleration control.

According to the present disclosure, it is possible to provide a control device, a control method, and a computer-readable recording medium storing a control program capable of appropriately decelerating a moving object according to a situation during autonomous exit of the moving object.

### BRIEF DESCRIPTION OF DRAWINGS

Exemplary embodiment(s) of the present invention will be described in detail based on the following figures, wherein:

FIG. 1 is a side view showing an example of a vehicle whose movement is controlled by a control device according to an embodiment

FIG. 2 is a top view of the vehicle shown in FIG. 1;

FIG. 3 is a block diagram showing an internal configuration of the vehicle shown in FIG. 1 ;

FIG. 4 is a diagram showing an example of a hardware configuration of an information terminal;

FIG. 5 is a diagram showing a state where exit instruction control on the vehicle is performed by using the information terminal from an outside of the vehicle:

FIG. 6 is a flowchart showing the exit instruction control performed by the information terminal during autonomous exit;

FIG. 7 is a flowchart showing the exit instruction control performed by the information terminal during the autonomous exit;

FIG. 8 is a diagram showing an example of an autonomous exit guidance screen displayed on the information terminal during the autonomous exit;

FIG. 9 is a diagram showing an example of a child protection screen displayed on the information terminal during autonomous parking;

FIG. 10 is a diagram showing an example of an exit instruction screen displayed on the information terminal during the autonomous exit;

FIG. 11 is a diagram showing an example of a disclaimer notification and agreement screen displayed on the information terminal during the autonomous parking;

FIG. 12 is a diagram showing an example of an ignition-on screen displayed on the information terminal during the autonomous exit;

FIG. 13 is a diagram showing an example of an exit direction selection screen displayed on the information terminal during the autonomous parking;

FIG. 14 is a diagram showing an example of an exit direction confirmation screen displayed on the information terminal during the autonomous parking:

FIG. 15 is a diagram showing an example of a connection-with-vehicle screen displayed on the information terminal during the autonomous parking:

FIG. 16 is a diagram showing an example of an operation input start screen displayed on the information terminal during the autonomous exit;

FIG. 17 is a diagram showing an example of an operation input screen displayed on the information terminal during the autonomous exit:

FIG. 18 is a diagram showing an example of an autonomous exit completion screen displayed on the information terminal during the autonomous exit:

FIG. 19 is a flowchart showing exit execution control on the vehicle during the autonomous exit;

FIG. 20 is a diagram showing an example of movement of the vehicle to a target movement position:

FIG. 21 is a diagram showing an example of deceleration characteristics and vehicle speed characteristics of first deceleration control: and

FIG. 22 is a diagram showing an example of deceleration characteristics and vehicle speed characteristics of second deceleration control.

### DESCRIPTION OF EMBODIMENTS

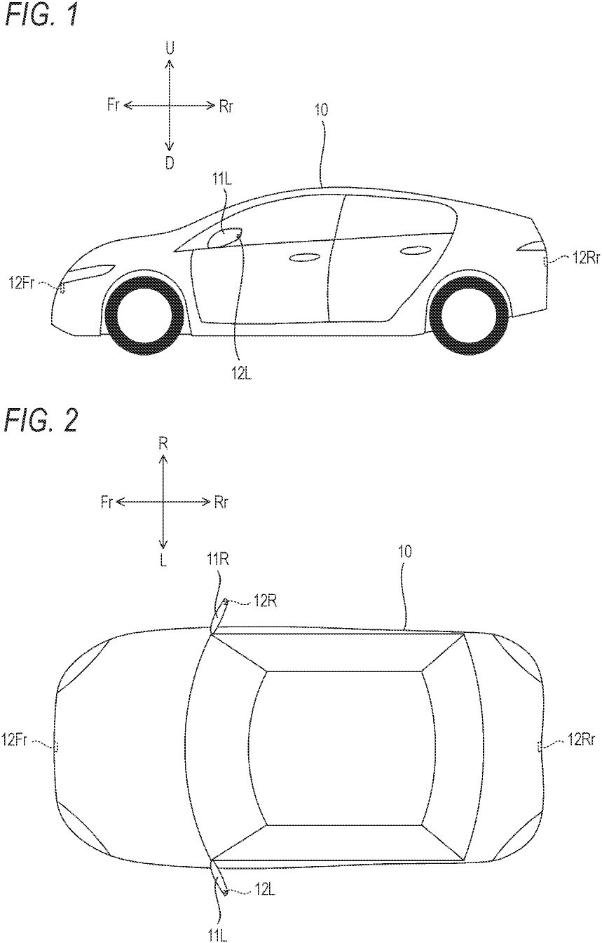

Hereinafter, an embodiment of a control device, a control method, and a computer-readable recording medium storing a control program according to the present disclosure will be described with reference to the accompanying drawings. The drawings are viewed in directions of reference numerals. In addition, in the present specification and the like, in order to simplify and clarify the description, a front-rear direction, a left-right direction, and an upper-lower direction are described according to directions viewed from a driver of a vehicle 10 shown in FIGS. 1 and 2. In the drawings, a front side of the vehicle 10 is denoted by Fr, a rear side thereof is denoted by Rr, a left side thereof is denoted by L, a right side thereof is denoted by R, an upper side thereof is denoted by U, and a lower side thereof is denoted by D.

### Vehicle 10 Whose Movement Is Controlled by Control Device of Present Disclosure

FIG. 1 is a side view of the vehicle 10 whose movement is controlled by the control device of the present disclosure. FIG. 2 is a top view of the vehicle 10 shown in FIG. 1. The vehicle 10 is an example of a moving object of the present disclosure.

The vehicle 10 is an automobile including a drive source (not shown) and wheels including driving wheels driven by power of the drive source and steering wheels that are steerable. In the present embodiment, the vehicle 10 is a four-wheeled automobile including a pair of left and right front wheels and a pair of left and right rear wheels. The drive source of the vehicle 10 is, for example, an electric motor. The drive source of the vehicle 10 may also be an internal combustion engine such as a gasoline engine or a diesel engine, or a combination of an electric motor and an internal combustion engine. In addition, the drive source of the vehicle 10 may drive the pair of left and right front wheels, may drive the pair of left and right rear wheels, or may drive four wheels, that is, the pair of left and right front wheels and the pair of left and right rear wheels. The front wheels and the rear wheels may both be steering wheels that are steerable, or the front wheels or the rear wheels may be steering wheels that are steerable.

The vehicle 10 further includes side mirrors 11L and 11R. The side mirrors 11L and 11R are mirrors (rearview mirrors) that are provided outside front seat doors of the vehicle 10 for the driver to check the rear side and a rear lateral side. Each of the side mirrors 11L and 1lR is fixed to a body of the vehicle 10 by a rotation shaft extending in a vertical direction, and can be opened and closed by rotating about the rotation shaft.

The vehicle 10 further includes a front camera 12Fr, a rear camera 12Rr, a left side camera 12L. and a right side camera 12R. The front camera 12Fr is a digital camera that is provided at a front portion of the vehicle 10 and captures an image of the front side of the vehicle 10. The rear camera 12Rr is a digital camera that is provided at a rear portion of the vehicle 10 and captures an image of the rear side of the vehicle 10. The left side camera 12L is a digital camera that is provided on the left side mirror 11L of the vehicle 10 and captures an image of the left side of the vehicle 10. The right side camera 12R is a digital camera that is provided on the right side mirror 11R of the vehicle 10 and captures an image of the right side of the vehicle 10.

### Internal Configuration of Vehicle 10

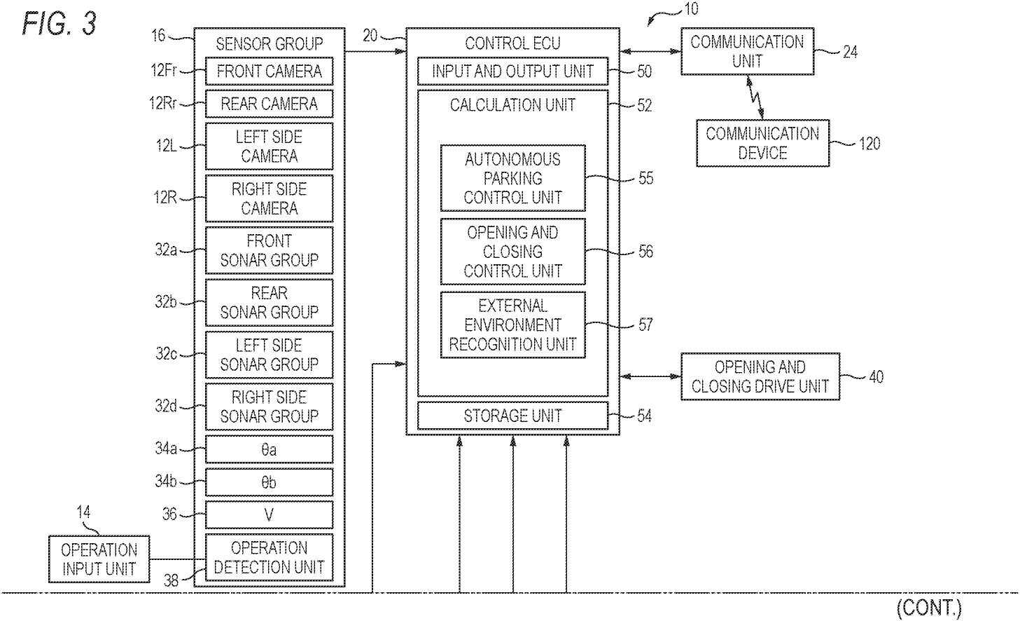

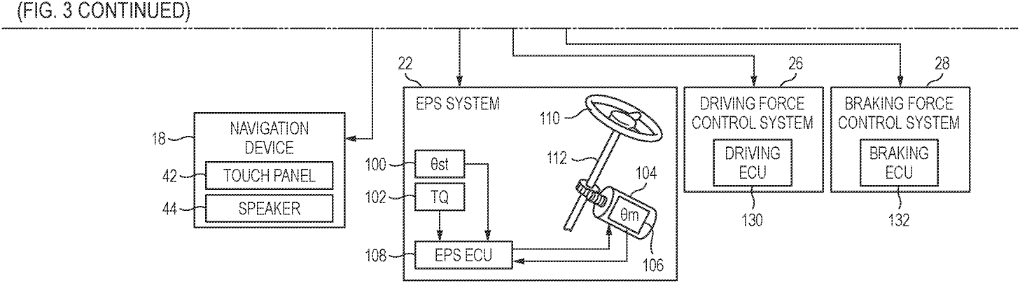

FIG. 3 is a block diagram showing an example of an internal configuration of the vehicle 10 shown in FIG. 1. As shown in FIG. 3, the vehicle 10 includes a sensor group 16, a navigation device 18. a control electronic control unit (ECU) 20, an electric power steering (EPS) system 22, and a communication unit 24. The vehicle 10 further includes a driving force control system 26 and a braking force control system 28.

The sensor group 16 acquires various detection values used for control performed by the control ECU 20. The sensor group 16 includes the front camera 12Fr, the rear camera 12Rr, the left side camera 12L, and the right side camera 12R. In addition, the sensor group 16 includes a front sonar group 32a, a rear sonar group 32b. a left side sonar group 32c. and a right side sonar group 32d. In addition, the sensor group 16 includes wheel sensors 34a and 34b, a vehicle speed sensor 36, and an operation detection unit 38. The sensor group 16 may include a radar.

The front camera 12Fr, the rear camera 12Rr, the left side camera 12L, and the right side camera 12R acquire recognition data (for example, surrounding image) for recognizing an external environment of the vehicle 10 by capturing images of surroundings of the vehicle 10. Surrounding images captured by the front camera 12Fr, the rear camera 12Rr, the left side camera 12L. and the right side camera 12R are referred to as a front image, a rear image, a left side image, and a right side image, respectively. An image formed by the left side image and the right side image may be referred to as a side image.

The front sonar group 32a, the rear sonar group 32b. the left side sonar group 32c, and the right side sonar group 32d emit sound waves to the surroundings of the vehicle 10 and receive reflected sounds from other objects. The front sonar group 32a includes, for example, four sonars. The sonars constituting the front sonar group 32a are respectively provided on an obliquely left front side, a front left side, a front right side, and an obliquely right front side of the vehicle 10. The rear sonar group 32b includes, for example, four sonars. The sonars constituting the rear sonar group 32b are respectively provided on an obliquely left rear side, a rear left side, a rear right side, and an obliquely right rear side of the vehicle 10. The left side sonar group 32c includes, for example, two sonars. The sonars constituting the left side sonar group 32c are provided in a front side and a rear side of a left side portion of the vehicle 10, respectively. The right side sonar group 32d includes, for example, two sonars. The sonars constituting the right side sonar group 32d are provided in the front of a right side portion of the vehicle 10 and the rear of the right side portion, respectively. The front sonar group 32a. the rear sonar group 32b. the left side sonar group 32c, and the right side sonar group 32d acquire detection data (for example, obstacle information) for detecting an obstacle in the surrounding area of the vehicle 10.

The wheel sensors 34a and 34b detect rotation angles of the wheels of the vehicle 10. The wheel sensors 34a and 34b may be implemented by angle sensors or displacement sensors. The wheel sensors 34a and 34b output detection pulses each time the wheels rotate by predetermined angles. The detection pulses output from the wheel sensors 34a and 34b are used to calculate the rotation angles of the wheels and rotation speeds of the wheels. A movement distance of the vehicle 10 is calculated based on the rotation angles of the wheels. The wheel sensor 34a detects, for example, a rotation angle θa of the left rear wheel. The wheel sensor 34b detects, for example, a rotation angle θb of the right rear wheel.

The vehicle speed sensor 36 detects a speed of a vehicle body of the vehicle 10, that is, a vehicle speed V, and outputs the detected vehicle speed V to the control ECU 20. The vehicle speed sensor 36 detects the vehicle speed V based on, for example, rotation of a countershaft of a transmission.

The operation detection unit 38 detects a content of an operation performed by a user using an operation input unit 14, and outputs the detected content of the operation to the control ECU 20. The operation input unit 14 includes, for example, various user interfaces such as a side mirror switch that switches opened and closed states of the side mirrors 11L and 11R, and a shift lever (a select lever or a selector).

The navigation device 18 detects a current position of the vehicle 10 by using, for example, a global positioning system (GPS), and guides the user along a route toward a destination. The navigation device 18 includes a storage device (not shown) that includes a map information database.

The navigation device 18 includes a touch panel 42 and a speaker 44. The touch panel 42 functions as an input device and a display device of the control ECU 20. The speaker 44 outputs various types of guide information to the user of the vehicle 10 by voice.

The touch panel 42 is configured to input various commands to the control ECU 20. For example, the user can input a command related to movement assistance of the vehicle 10 via the touch panel 42. The movement assistance includes parking assistance and exit assistance of the vehicle 10. In addition, the touch panel 42 is configured to display various screens related to a control content of the control ECU 20. For example, a screen related to the movement assistance of the vehicle 10 is displayed on the touch panel 42. Specifically, a parking assistance button for requesting the parking assistance of the vehicle 10 and an exit assistance button for requesting the exit assistance are displayed on the touch panel 42. The parking assistance button includes an autonomous parking button for requesting parking by autonomous steering of the control ECU 20 and a guidance parking button for requesting guidance when parking the vehicle by an operation of the driver. The exit assistance button includes an autonomous exit button for requesting exit by the autonomous steering of the control ECU 20 and a guidance exit button for requesting guidance when the exit of the vehicle is performed by an operation of the driver. Constituent elements other than the touch panel 42, for example, a smartphone or a tablet terminal may be used as the input device or the display device.

The control ECU 20 includes an input and output unit 50, a calculation unit 52, and a storage unit 54. The calculation unit 52 is implemented by, for example, a central processing unit (CPU). The calculation unit 52 performs various types of control by controlling each unit based on a program stored in the storage unit 54. In addition, the calculation unit 52 receives and outputs signals from and to each unit connected to the control ECU 20 via the input and output unit 50. The calculation unit 52 is an example of the control device according to the present disclosure.

The calculation unit 52 includes an autonomous parking control unit 55 that performs movement execution control on the vehicle 10. an opening and closing control unit 56 that controls opening and closing of an opening and closing body of the vehicle 10, and an external environment recognition unit 57 that recognizes external environment information of the vehicle 10. The autonomous parking control unit 55 is an example of a control unit in the present disclosure.

The autonomous parking control unit 55 performs autonomous parking assistance and autonomous exit assistance on the vehicle 10 by autonomous steering in which a steering 110 is autonomously operated under control of the autonomous parking control unit 55. In the autonomous parking assistance and the autonomous exit assistance, an accelerator pedal (not shown), a brake pedal (not shown), and the operation input unit 14 are autonomously operated. In addition, the autonomous parking control unit 55 performs guidance parking assistance and guidance exit assistance when the driver performs manual parking and manual exit of the vehicle 10 by operating the accelerator pedal, the brake pedal, and the operation input unit 14.

For example, based on the recognition data of the external environment of the vehicle 10 acquired by the front camera 12Fr, the rear camera 12Rr, the left side camera 12L. and the right side camera 12R and a parking space designated by the user, the autonomous parking control unit 55 performs parking execution control for autonomously parking the vehicle 10 in the predetermined parking space and exit execution control for causing the vehicle 10 to autonomously exit from the predetermined parking space to a target movement position. The autonomous parking control unit 55 executes the parking execution control and the exit execution control in accordance with an instruction signal externally input via the input and output unit 50. The input from the outside includes an input through wireless communication from an information terminal or the like carried by the user of the vehicle 10. The information terminal will be described later. The autonomous parking control unit 55 transmits information related to the parking execution control and the exit execution control to an external information terminal via the input and output unit 50.

Specifically, in the exit execution control on the vehicle 10, based on a positional relationship between the opening and closing body (driver seat door) of a driver seat of the vehicle 10 and the information terminal carried by the user of the vehicle 10, the autonomous parking control unit 55 sets the target movement position to which the vehicle 10 is moved. The target movement position is a position at which the user can easily access the opening and closing body of the driver seat. The opening and closing body of the driver seat is an opening and closing body that the driver usually gets in and out, and is the closest opening and closing body to the driver seat. The information terminal carried by the user refers to a terminal possessed by the user waiting at a position away from a position where the vehicle 10 exits.

In the exit execution control on the vehicle 10, the autonomous parking control unit 55 can cause the vehicle 10 to stop by deceleration control according to a movement state of the vehicle 10. The deceleration control includes first deceleration control that is executed when an exit instruction signal instructing the exit from the information terminal of the user is stopped (discontinued) or when an exit stop signal instructing stop of the exit is input and second deceleration control that is executed as the vehicle 10 approaches the target movement position.

The autonomous parking control unit 55 sets deceleration of the speed of the vehicle 10 due to the second deceleration control to be smaller than the deceleration of the speed of the vehicle 10 due to the first deceleration control. The deceleration is an amount of deceleration per unit time. Therefore, a time from the start of the deceleration of the vehicle 10 running at the same speed to the stop is longer in the second deceleration control than in the first deceleration control. The deceleration is determined by a hydraulic pressure of a brake, that is, an amount of depression of the brake pedal.

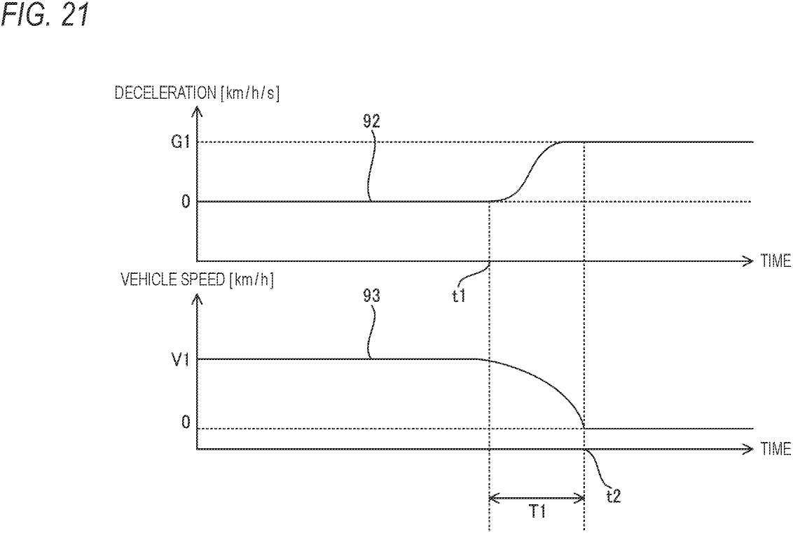

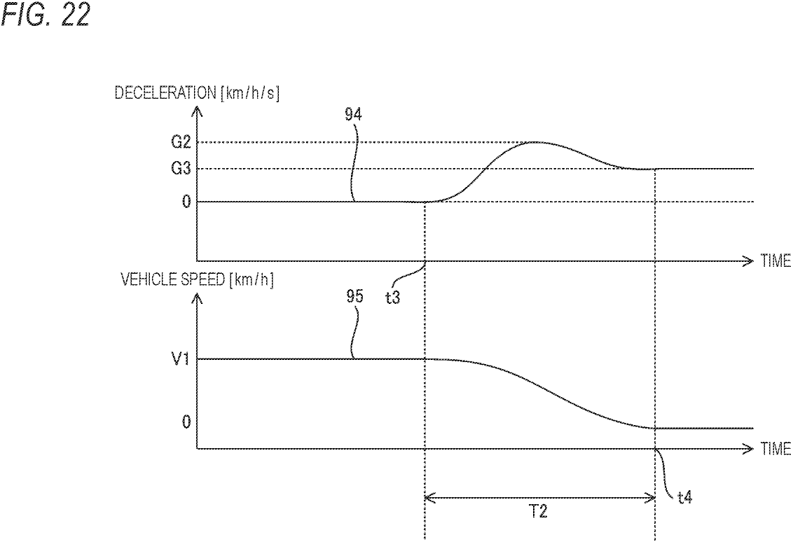

The first deceleration control is control that does not reduce the deceleration of the vehicle 10 until the vehicle 10 stops. On the other hand, the second deceleration control is control that reduces the deceleration of the vehicle 10 until the vehicle 10 stops. In other words, the first deceleration control is deceleration control capable of stopping the vehicle 10 in a shorter time than the second deceleration control. The second deceleration control is deceleration control capable of stopping the vehicle 10 more smoothly than the first deceleration control. This point will be described later with reference to FIGS. 21 and 22.

The autonomous parking control unit 55 changes the deceleration of the second deceleration control based on the state of the user of the vehicle 10. For example, the autonomous parking control unit 55 determines a time margin of the user based on schedule information of the user, and determines the deceleration of the second deceleration control. Specifically, the autonomous parking control unit 55 increases the deceleration when the schedule information indicates that the user is in a hurry, and reduces the deceleration when the user is not in a hurry. The autonomous parking control unit 55 can receive the schedule information of the user from the information terminal of the user.

The autonomous parking control unit 55 changes the deceleration of the second deceleration control based on the external environment of the vehicle 10. For example, the autonomous parking control unit 55 confirms current weather conditions and determines the deceleration of the second deceleration control. Specifically, the autonomous parking control unit 55 increases the deceleration in bad weather such as rain, high temperature, low temperature, and strong wind.

The autonomous parking control unit 55 changes the deceleration of the second deceleration control based on setting of the user of the vehicle 10. That is, the second deceleration control is control for decelerating the vehicle 10 according to deceleration characteristics set by the user. However, the deceleration of the second deceleration control can be set within a range smaller than that of the deceleration of the first deceleration control.

The autonomous parking control unit 55 changes the deceleration of the second deceleration control based on driving characteristics of the user of the vehicle 10. The second deceleration control is control for decelerating the vehicle 10 according to the deceleration characteristics based on a driving history of the user of the vehicle 10. For example, the autonomous parking control unit 55 sets the deceleration of the second deceleration control such that the deceleration characteristics similar to the deceleration characteristics when the user drives are obtained.

The autonomous parking control unit 55 determines whether the opening and closing body of the vehicle 10 can be opened or closed when the vehicle 10 exits to a movement position as a target. The autonomous parking control unit 55 determines whether the opening and closing body can be opened or closed based on a recognition result of the external environment obtained by the external environment recognition unit 57. The autonomous parking control unit 55 determines whether the opening and closing body can be opened or closed according to a distance between the opening and closing body of the vehicle 10 and surrounding objects existing around the vehicle, and according to a type of the opening and closing body (tail gate, slide door, hinge door, and the like). The autonomous parking control unit 55 sets the target movement position of the vehicle 10 based on a determination result as to whether the opening and closing body can be opened or closed.

The autonomous parking control unit 55 performs predetermined opening and closing of the opening and closing body when the vehicle 10 reaches the set target movement position. The opening and closing of the opening and closing body includes, for example, enabling manual opening and closing of the opening and closing body (unlocking the opening and closing body), autonomously opening and closing the opening and closing body, and the like. In addition, the opening and closing of the opening and closing body may include, for example, displaying guide information related to the opening and closing body on the information terminal.

The opening and closing control unit 56 performs opening and closing control to autonomously open and close the opening and closing body such as a tail gate, a slide door, and a hinge door of the vehicle 10. The opening and closing control unit 56 performs the opening and closing control on the opening and closing body reserved for the opening and closing based on an opening and closing signal from the autonomous parking control unit 55.

The external environment recognition unit 57 recognizes the external environment of the vehicle 10 based on the surrounding images of the vehicle 10 which are captured by the front camera 12Fr, the rear camera 12Rr, the left side camera 12L, and the right side camera 12R. The external environment recognition unit 57 can also recognize the external environment of the vehicle 10 based on information acquired by the sonar groups 32a to 32d or a radar. The external environment recognition unit 57 recognizes the presence of surrounding objects that may be obstacles when opening and closing the opening and closing body of the vehicle 10 based on the external environment information acquired by the cameras, sonars, and radar.

The EPS system 22 includes a steering angle sensor 100, a torque sensor 102, an EPS motor 104, a resolver 106, and an EPS ECU 108. The steering angle sensor 100 detects a steering angle θst of the steering 110. The torque sensor 102 detects a torque TQ applied to the steering wheel 110.

The EPS motor 104 applies a driving force or a reaction force to a steering column 112 connected to the steering 110, thereby enabling assistance of an operation performed by an occupant on the steering 110 and enabling the autonomous steering during the parking assistance. The resolver 106 detects a rotation angle θm of the EPS motor 104. The EPS ECU 108 controls the entire EPS system 22. The EPS ECU 108 includes an input and output unit (not shown), a calculation unit (not shown), and a storage unit (not shown).

The communication unit 24 enables wireless communication with another communication device 120. Another communication device 120 is a base station, a communication device of other vehicles, or information terminal such as a smartphone or a tablet terminal that can be carried by the user of the vehicle 10. For example, the communication unit 24 includes an ultra wide band (UWB) interface for performing UWB communication with the information terminal.

The driving force control system 26 includes a driving ECU 130. The driving force control system 26 executes driving force control on the vehicle 10. The driving ECU 130 controls a driving force of the vehicle 10 by controlling an engine (not shown) or the like based on an operation performed by the user on the accelerator pedal (not shown).

The braking force control system 28 includes a braking ECU 132. The braking force control system 28 executes braking force control on the vehicle 10. The braking ECU 132 controls a braking force of the vehicle 10 by controlling a brake mechanism (not shown) or the like based on an operation performed on the brake pedal (not shown) by the user.

### Hardware Configuration of Information Terminal

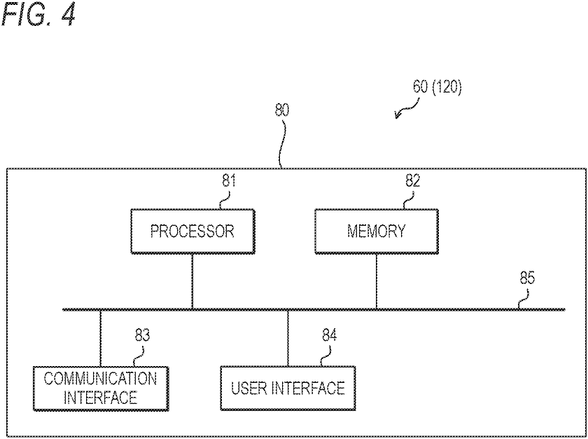

FIG. 4 shows an example of a hardware configuration of an information terminal 60. Hardware of the information terminal 60 may be implemented by, for example, an information processing device 80 shown in FIG. 4. The information processing device 80 includes a processor 81, a memory 82, a communication interface 83, and a user interface 84. The processor 81, the memory 82, the communication interface 83, and the user interface 84 are connected by, for example, a bus 85.

The processor 81 is a circuit that performs signal processing, and is, for example, a central processing unit (CPU) that controls the entire information processing device 80. The processor 81 may be implemented by another digital circuit such as a field programmable gate array (FPGA) or a digital signal processor (DSP). In addition, the processor 81 may be implemented by combining a plurality of digital circuits.

The memory 82 includes, for example, a main memory and an auxiliary memory. The main memory is, for example, a random access memory (RAM). The main memory is used as a work area of the processor 81. The memory 82 records, for example, calendar information as the schedule information of the user.

The auxiliary memory is, for example, a nonvolatile memory such as a magnetic disk, an optical disk, or a flash memory. Various programs for causing the information processing device 80 to operate are stored in the auxiliary memory. The programs stored in the auxiliary memory are loaded onto the main memory and executed by the processor 81.

In addition, the auxiliary memory may include a portable memory removable from the information processing device 80. Examples of the portable memory include a universal serial bus (USB) flash drive, a memory card such as a secure digital (SD) memory card, and an external hard disk drive.

The communication interface 83 is a communication interface that performs the wireless communication with an outside of the information processing device 80 (for example, the communication unit 24 of the vehicle 10). For example, the communication interface 83 includes the UWB interface for the UWB communication with the vehicle 10 The communication interface 83 is controlled by the processor 81.

The user interface 84 includes, for example, an input device that receives an operation input from the user and an output device that outputs information to the user. The input device can be implemented by, for example, a touch panel. The output device can be implemented by, for example, a display and a speaker. The user interface 84 is controlled by the processor 81.

The processor 81 performs the movement instruction control instructing the movement of the vehicle 10. For example, the processor 81 performs the movement instruction control on the vehicle 10 based on a specific operation performed by the user on a terminal screen of the information terminal 60. The movement instruction control includes, for example, a parking instruction control for autonomously parking the vehicle 10 in a predetermined parking space and an exit instruction control for causing the vehicle 10 to autonomously exit from the predetermined parking space to the target movement position. The specific operation of the user includes, for example, a swiping operation for causing the vehicle 10 to move, a tap operation for reserving parking and exit plans, and the like.

Specifically, in the exit instruction control, the processor 81 receives the exit plan of the vehicle 10 based on a reservation operation performed by the user on the terminal screen. The exit plan is a plan related to the autonomous exit of the vehicle 10. and includes, for example, a plan of a direction in which the vehicle 10 exits (an exit direction of the vehicle 10) when the vehicle 10 exits from a space where the vehicle 10 is parked, or whether to open and close a predetermined opening and closing body during the exit. The processor 81 can accept, for example, an opening and closing reservation for opening and closing the opening and closing body of the driver seat during the exit, and an opening and closing reservation for opening and closing a specific opening and closing body other than the opening and closing body of the driver seat The opening and closing reservation of the opening and closing body refers to a reservation of the opening and closing body that the user wants to preferentially open and close when the exit of the vehicle 10 is completed. The processor 81 can receive the exit plan in advance at or before the start of the autonomous exit.

In addition, the processor 81 can receive the deceleration setting in the second deceleration control on the vehicle 10 that is input based on an input operation performed by the user on the terminal screen of the information terminal 60.

The processor 81 transmits, to the vehicle 10, a parking instruction signal for autonomously parking the vehicle 10 and an exit instruction signal for causing the vehicle 10 to autonomously exit based on the specific operation on the terminal screen of the information terminal 60. In addition, the processor 81 transmits, to the vehicle 10. the deceleration of the second deceleration control set by the user and the schedule information of the user which is stored in the memory 82. An application capable of controlling the movement of the vehicle 10 by transmitting and receiving information related to the movement control on the vehicle 10 to and from the vehicle 10 is installed in the information terminal 60.

### Example of Movement Instruction Control Performed by Information Terminal 60

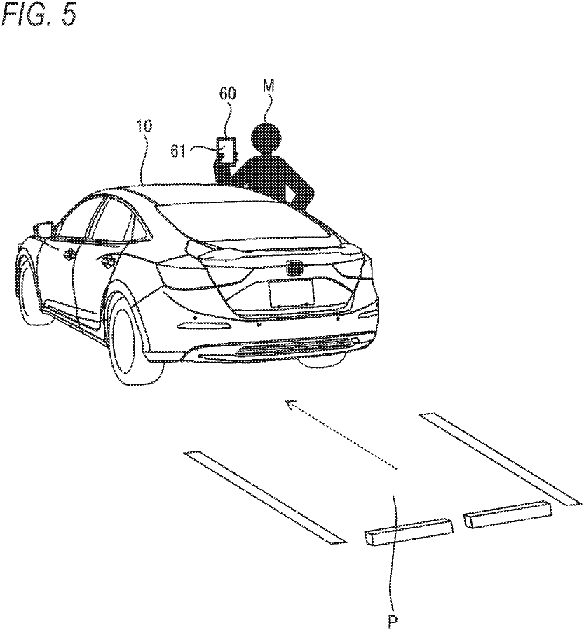

FIG. 5 is a diagram showing an example of a state where a user M of the vehicle 10 performs the exit instruction control for causing the vehicle 10 autonomously exit from a parking space P by using the information terminal 60 carried by the user M in the outside of the vehicle 10.

When the user M touches a terminal screen 61 configured as the touch panel, the information terminal 60 transmits the exit instruction signal instructing the autonomous exit of the vehicle 10 to the vehicle 10 by the wireless communication. The vehicle 10 receives the exit instruction signal from the information terminal 60. and performs the exit execution control for causing the vehicle 10 to autonomously exit to the target movement position while performing the wireless communication with the information terminal 60 in accordance with the received exit instruction signal. The state in the shown example indicates a state where the vehicle 10 exits to a position where the user M can easily access a front right door, which is the driver seat of the vehicle 10. As the wireless communication between the information terminal 60 and the vehicle 10, for example, UWB (registered trademark), bluetooth low energy (BLE, registered trademark), or near field communication (NFC, registered trademark) is used.

### Processing Performed by Information Terminal 60 During Autonomous Exit

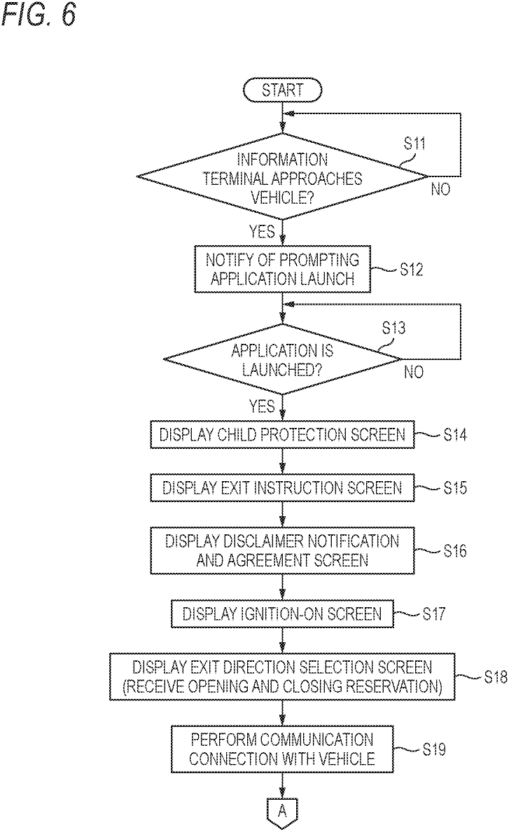

Next, an example of the exit instruction control performed by the information terminal 60 during the autonomous exit will be described with reference to FIGS. 6 to 18.

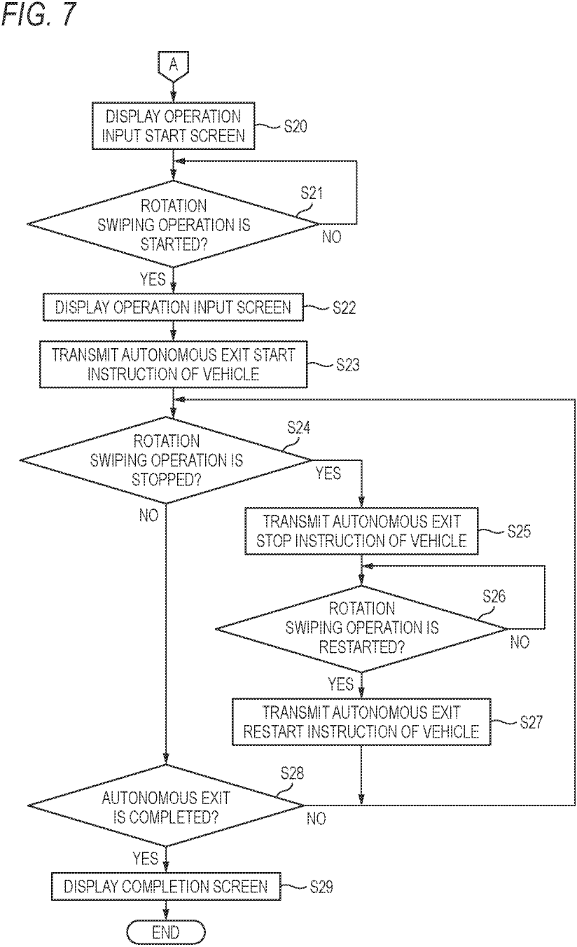

FIGS. 6 and 7 are flowcharts showing the exit instruction control performed by the processor 81 of the information terminal 60 during the autonomous exit. FIGS. 7 to 18 are diagrams showing examples of images displayed on the information terminal 60 during the autonomous exit.

For example, the user M attempts to cause the vehicle 10 to exit from a parking lot. The user M possesses the information terminal 60.

The processor 81 of the information terminal 60 determines whether the information terminal 60 approaches the vehicle 10, that is, whether the information terminal 60 approaches a distance at which the wireless communication with the vehicle 10 is available (step S11).

In step S11. if the information terminal 60 does not approach the vehicle 10 to the distance at which the wireless communication is available (step S11: No), the processor 81 repeats the processing of step S11 until the wireless communication is available.

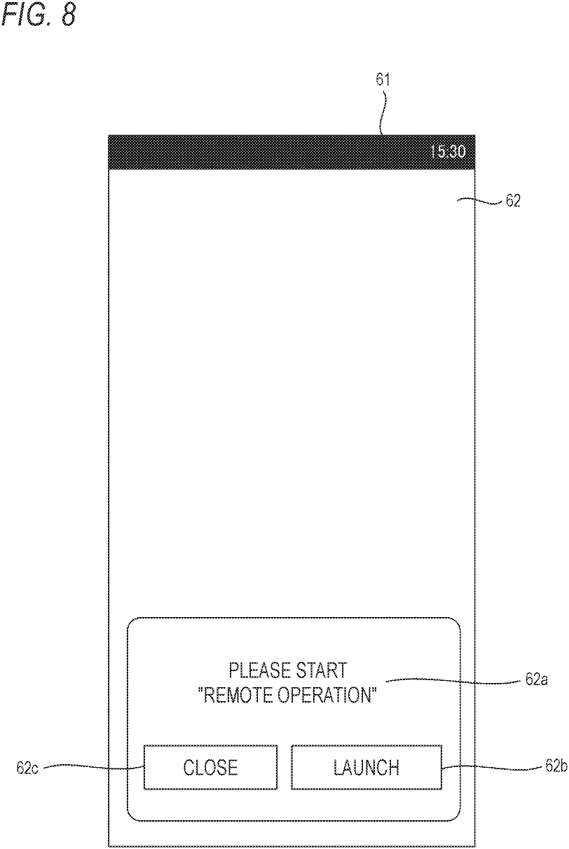

In step S11, if the information terminal 60 approaches the vehicle 10 to the distance at which the wireless communication is available (step S11: Yes), the processor 81 displays, for example, an autonomous exit guidance screen 62 as shown in FIG. 8 on the terminal screen 61, and prompts the user to launch an autonomous exit application of the vehicle 10 (step S12). The processor 81 displays, on the autonomous exit guidance screen 62, for example, a notification message 62b prompting the user to launch the autonomous exit application, such as “please start remote operation”, a launch button 62b for launching the application, and a close button 62c for closing the autonomous exit guidance screen 62.

Next, the processor 81 determines whether the autonomous exit application is launched (step S13).

In step S13, if the autonomous exit application is not launched (step S13: No), the processor 81 waits until the application is launched. However, if the application is not launched for a certain time, the processor 81 may autonomously close the autonomous exit guidance screen 62.

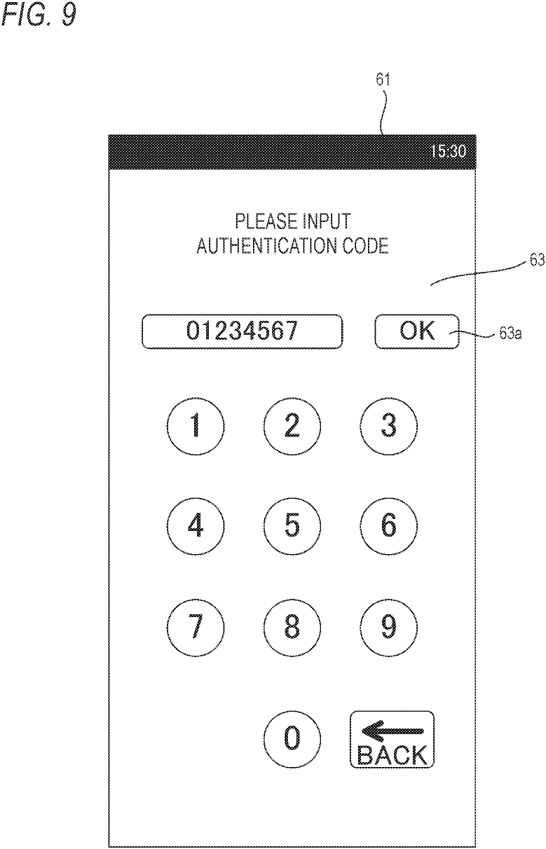

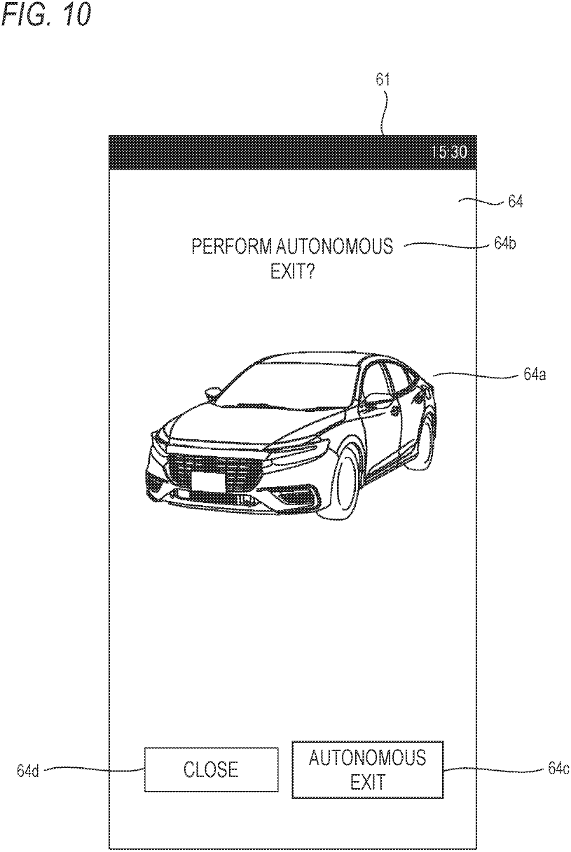

In step S13. if the autonomous exit application is launched (step S13: Yes), the processor 81 displays, for example, a child protection screen 63 as shown in FIG. 9 on the terminal screen 61 (step S14).

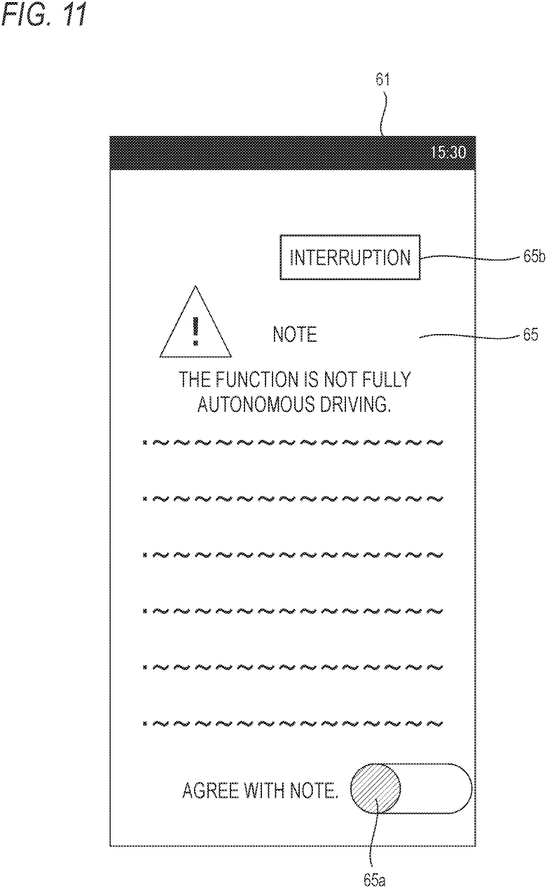

When an OK button 63a is touched after a predetermined authentication code is input in step S14, the processor 81 displays, for example, an exit instruction screen 64 for determining whether to perform the autonomous exit on the terminal screen 61 as shown in FIG. 10 (step S15). The processor 81 displays, on the exit instruction screen 64. for example, a vehicle image 64a of the vehicle 10 and a confirmation message 64b such as “perform autonomous exit?”. In addition, the processor 81 displays, on the exit instruction screen 64. an autonomous exit button 64c to be touched when the autonomous exit is to be performed, and a close button 64d for closing the exit instruction screen 64 when the autonomous exit is not to be performed.

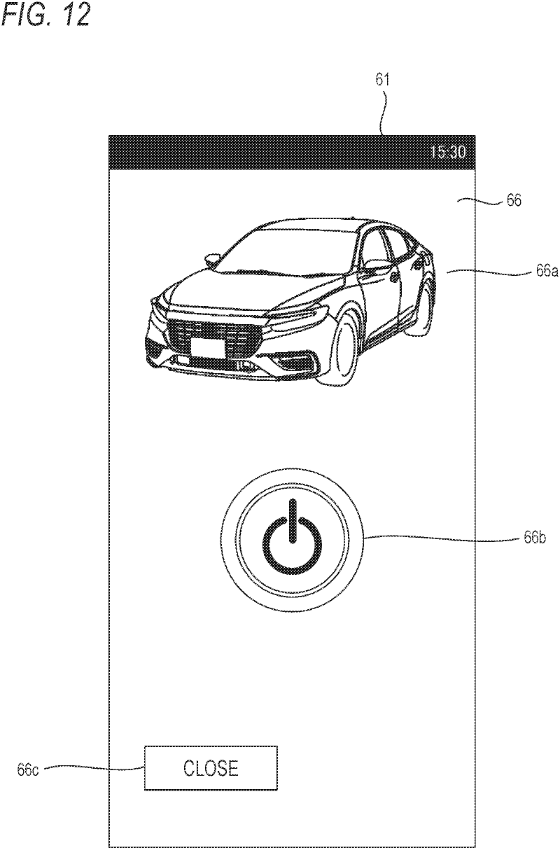

When the autonomous exit button 64c is touched in step S15. the processor 81 displays, for example, a disclaimer notification and agreement screen 65 stipulated relative to the autonomous exit on the terminal screen 61 as shown in FIG. 11 (step S16). When contents of the disclaimer notification and agreement screen 65 are agreed, an agree button 65a is swiped, and when the contents of the disclaimer notification and agreement screen are not agreed, an interruption button 65b for interrupting the autonomous exit is touched.

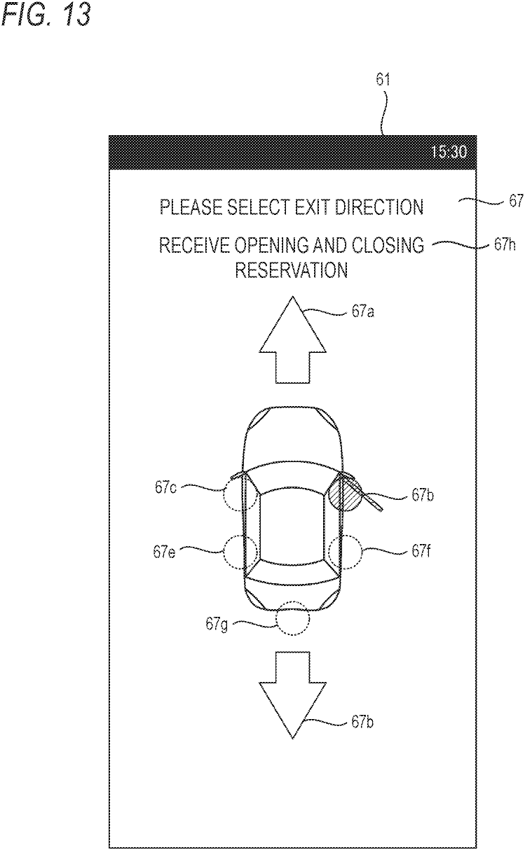

When the agree button 65a is swiped in step S16, the processor 81 displays, for example, an ignition-on screen 66 as shown in FIG. 12 on the terminal screen 61 to prompt selection of the exit direction of the vehicle 10 during the exit (step S17). The processor 81 displays, on the ignition-on screen 66. for example, a vehicle image 66a of the vehicle 10 and an ignition-on button 66b for performing the autonomous exit. In addition, the processor 81 displays, on the ignition-on screen 66, a close button 66c for closing the ignition-on screen 66 when the autonomous exit is to be stopped.

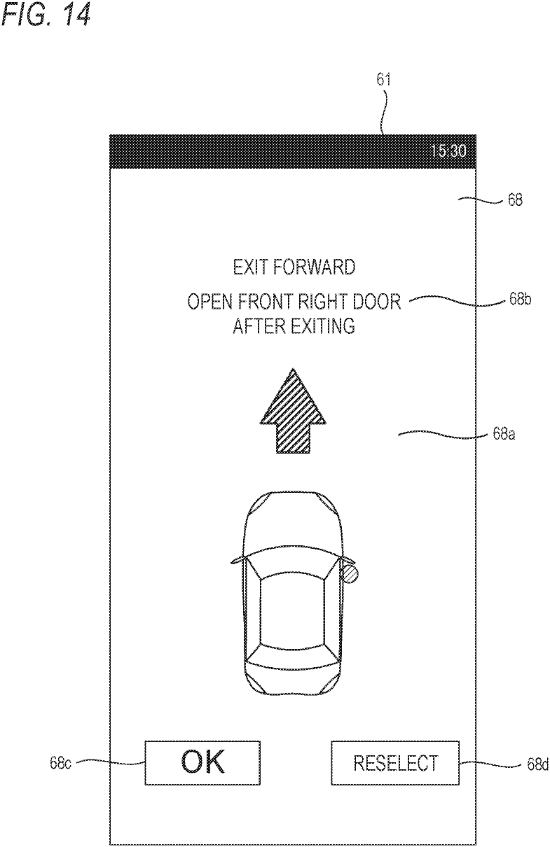

When the ignition-on button 66b is touched in step S17, the processor 81 displays, on the terminal screen 61, for example, an exit direction selection screen 67 for receiving the selection of the exit direction in the autonomous exit and an opening and closing reservation of the opening and closing body as shown in FIG. 13 (step S18). The processor 81 displays, on the exit direction selection screen 67, for example, a forward exit 67a where the vehicle moves forward and stops after exiting the parking space, and a rearward exit 67b where the vehicle moves rearward and stops after exitng the parking space. In addition, the processor 81 displays, on the exit direction selection screen 67, for example, a left front door 67c for reserving opening and closing of a left front door, a right front door 67d for reserving opening and closing of a right front door, a left rear door 67e for reserving opening and closing of a left rear door, a right rear door 67f for reserving opening and closing of a right rear door, and a tail gate 67g for reserving opening and closing of a tail gate. Furthermore, the processor 81 displays, on the exit direction selection screen 67, a selection message 67h such as “please select exit direction” and “receive opening and closing reservation”. On the exit direction selection screen 67, the user M can select the exit direction (67a. 67b) in which the vehicle 10 is to exit and the opening and closing bodies (67c to 67g) to be opened and closed by being touched.

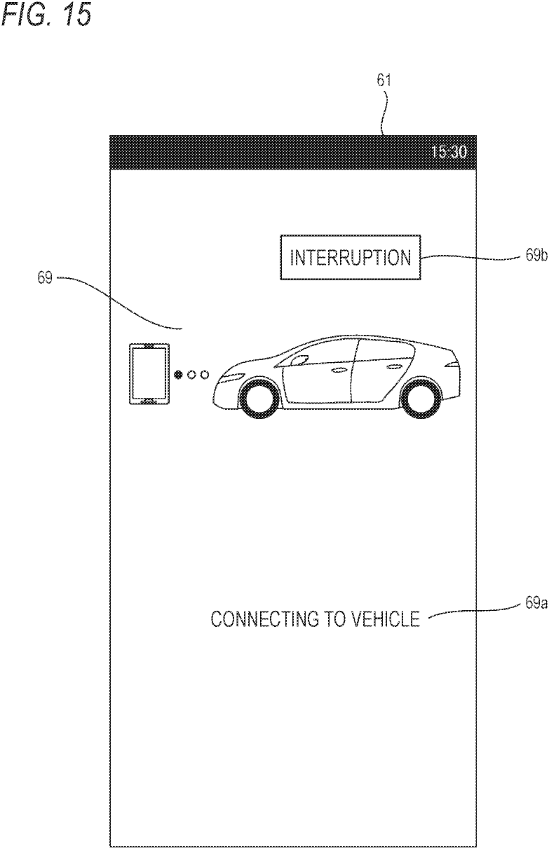

When one of the exit directions and the opening and closing bodies is selected on the exit direction selection screen 67, the processor 81 displays, for example, an exit direction confirmation screen 68 as shown in FIG. 14 on the terminal screen 61. The processor 81 displays, on the exit direction confirmation screen 68, an exit direction image 68a indicating the received exit direction and reserved opening and closing body. In a case of the example shown in the drawings, reception of the forward exit and the opening and closing reservation of the front right door are displayed. The processor 81 displays, on the exit direction confirmation screen 68, for example, a confirmation message 68b such as “exit forward” and “open front right door after exiting”. Futhermore, the processor 81 displays, on the exit direction confirmation screen 68, an OK button 68c for confirming the exit direction and the reserved opening and closing body, and a reselection button 68d for reselecting the exit direction and the reserved opening and closing body. When the reselection button 68d is touched, the processor 81 displays the exit direction selection screen 67 shown in FIG. 13 and enables selection of the exit direction and the opening and closing body again.

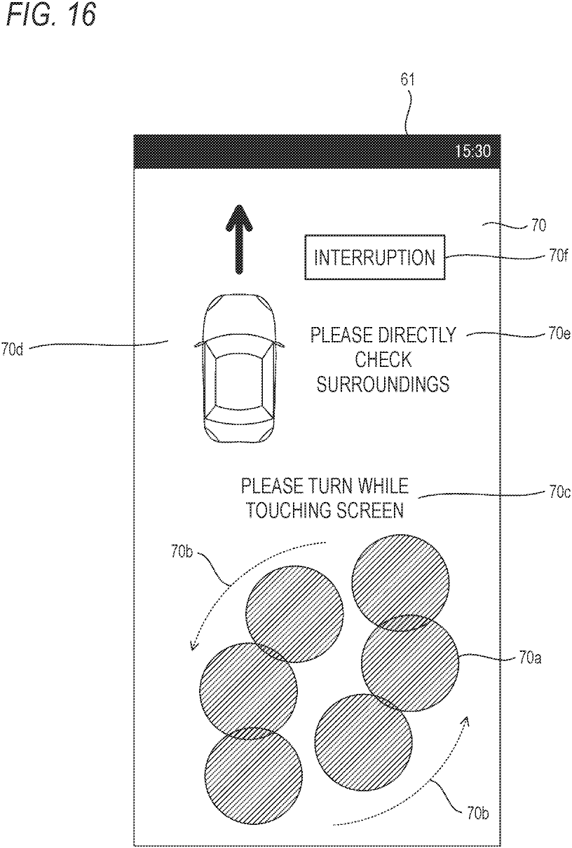

When the OK button 68c is touched on the exit direction confirmation screen 68 in FIG. 14 in step S18, the processor 81 starts communication connection with the vehicle 10. and displays, for example, a connection screen 69 as shown in FIG. 15 on the terminal screen 61 (step S19). The processor 81 displays, on the connection screen 69. a connection message 69a indicating that the connection with the vehicle 10 is in progress, such as “connecting to vehicle”, and an interruption button 69b for interrupting the connection. When the communication connection with the vehicle 10 is completed, the processor 81 transmits, to the vehicle 10, autonomous exit information including the exit direction and the reserved opening and closing body received during the exit in step S 18.

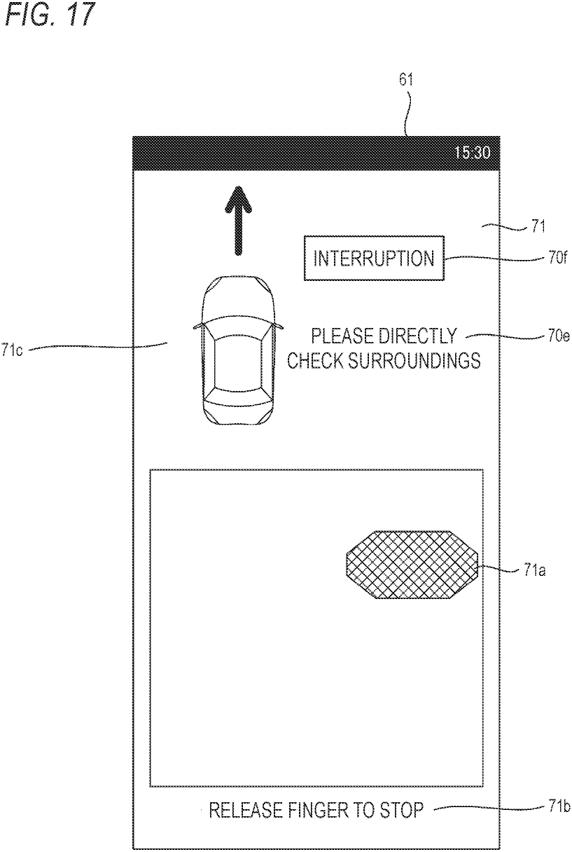

Next, the processor 81 proceeds ₜo processing in FIG. 7, and for example, as shown in FIG. 16, the processor 81 displays an operation input start screen 70 for guiding the start of the autonomous exit on the terminal screen 61 (step S20). The processor 81 displays, on the operation input start screen 70, an image in which six spheres 70a rotate counterclockwise in a direction indicated by arrows 70b, for example. That is, an image prompting a rotation swiping operation of sliding in a counterclockwise direction on the terminal screen 61 is displayed. In addition, the processor 81 displays, on the operation input start screen 70. a guidance message 70c such as “please turn while touching screen”. In addition, the processor 81 displays, on the operation input start screen 70. a vehicle image 70d indicating that the vehicle 10 exits forward and a reminder message 70e such as “please directly check surroundings”. Furthermore, the processor 81 displays, on the operation input start screen 70. an interruption button 70f for interrupting the autonomous exit.

Next, the processor 81 determines whether the rotation swiping operation is started on the terminal screen 61 (step S21).

In step S21. if the rotation swiping operation is not started (step S21: No), the processor 81 repeats the processing of step S21 and waits until the rotation swiping operation is started.

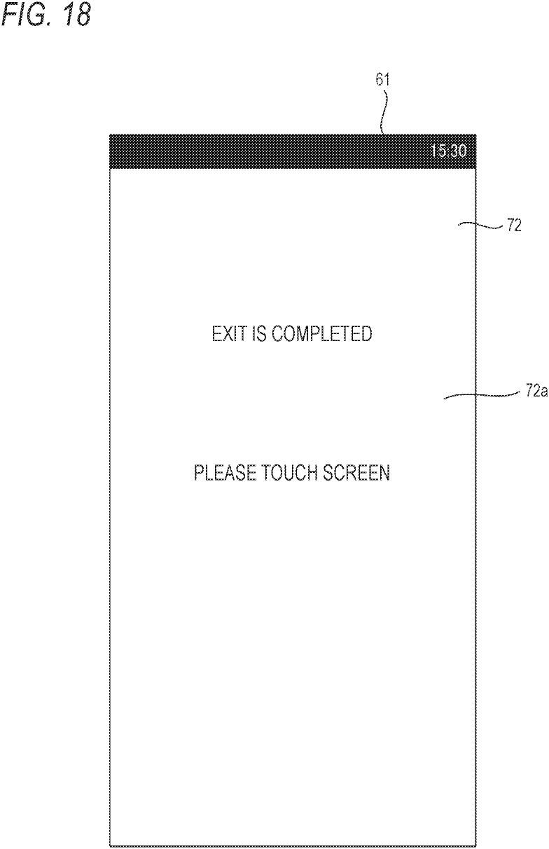

In step S21, if the rotation swiping operation is started (step S21: Yes), the processor 81 displays, for example, an operation input screen 71 indicating a state where the rotation swiping operation is performed during the exit on the terminal screen 61 as shown in FIG. 17 (step S22). The processor 81 displays, on the operation input screen 71, a movement icon 71a that moves following a position touched by the user M due to the rotation swiping operation, for example. In addition, the processor 81 displays a guide message 71b for stopping the autonomous exit of the vehicle 10, such as “release finger to stop”, for example. In addition, the processor 81 displays, on the operation input screen 71. a vehicle image 71c indicating that the forward exit of the vehicle 10 is in progress, and the reminder message 70e and the interruption button 70f as in FIG. 16. Accordingly, when the rotation swiping operation is performed on the terminal screen 61. the movement icon 71a rotationally moves following the touch position, and the vehicle 10 starts to move according to the rotational movement. When the rotation swiping operation is interrupted by removing the finger performing the rotation swiping operation from the terminal screen 61 or by stopping the rotation swiping operation, the rotational movement of the movement icon 71a is stopped, and the movement of the autonomous exit of the vehicle 10 is temporarily stopped.

Next, the processor 81 transmits, to the vehicle 10, an autonomous exit start instruction signal for starting the autonomous exit of the vehicle 10 (step S23). In response to the reception of the autonomous exit start instruction signal from the information terminal 60. the autonomous parking control unit 55 of the vehicle 10 starts the autonomous exit of the vehicle 10 in accordance with the received autonomous exit start instruction signal and based on the autonomous exit information including the exit direction and the reserved opening and closing body received during the exit.

Next, the processor 81 determines whether the rotation swiping operation on the terminal screen 61 is stopped (step S24).

In step S24. if the rotation swiping operation is stopped (step S24: Yes), the processor 81 transmits, to the vehicle 10, an autonomous exit stop instruction signal for stopping the autonomous exit of the vehicle 10 (step S25).

Next, the processor 81 determines whether the rotation swiping operation on the terminal screen 61 is restarted (step S26).

In step S26. if the rotation swiping operation is not restarted (step S26: No), the processor 81 waits until the rotation swiping operation is restarted.

In step S26. if the rotation swiping operation is restarted (step S26: Yes), the processor 81 transmits, to the vehicle 10, an autonomous exit restart instruction signal for instructing the autonomous exit of the vehicle 10 (step S27), returns to step S24. and repeats the processing.

Meanwhile, in step S24, if the rotation swiping operation is not stopped (step S24: No), the processor 81 determines whether the autonomous exit of the vehicle 10 is completed (step S28). Whether the autonomous exit is completed can be determined based on information related to autonomous exit execution control transmitted from the autonomous parking control unit 55 of the vehicle 10.

In step S28, if the autonomous exit is not completed (step S28: No), the processor 81 returns to step S24 and repeats the processing.

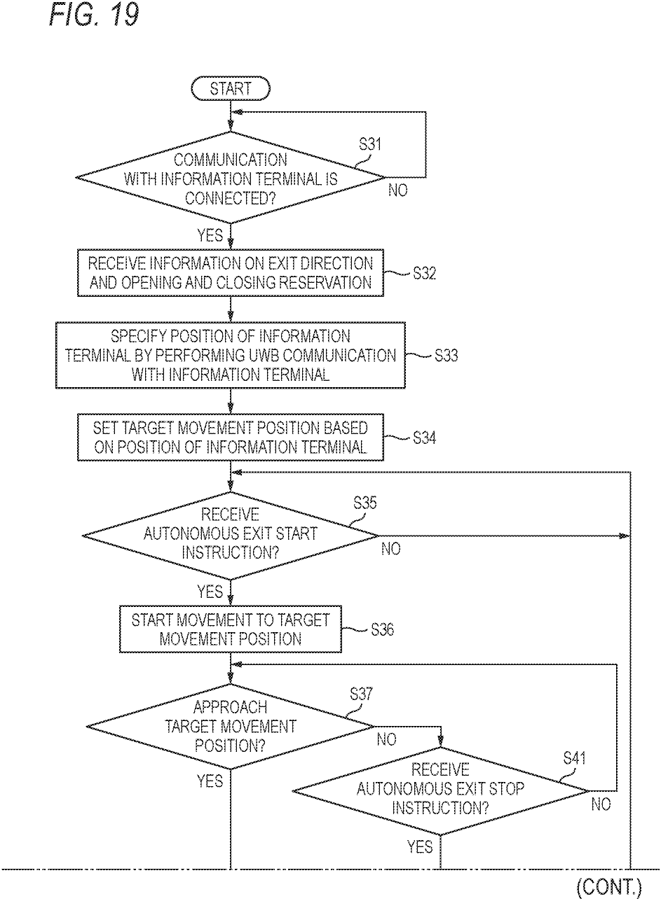

In step S28, if the autonomous exit is completed (step S28: Yes), the processor 81 displays, for example, an autonomous exit completion screen 72 as shown in FIG. 18 on the terminal screen 61 (step S29). The processor 81 displays, on the autonomous exit completion screen 72, for example, an exit completion message 72a such as “Exit is completed. Please touch screen.”. On the autonomous exit completion screen 72. if the terminal screen 61 is touched, the processor 81 ends the present exit instruction control during the autonomous exit.

In the above processing, the processor 81 transmits the autonomous exit start instruction signal to the vehicle 10 in step S23. transmits the autonomous exit stop instruction signal to the vehicle 10 in step S25 if the rotation swiping operation is stopped in step S24, and transmits the autonomous exit restart instruction signal to the vehicle 10 in step S27 if the rotation swiping operation is restarted in step S26, but the present disclosure is not limited thereto. For example, the processor 81 may continuously transmit the autonomous exit instruction signal to the vehicle 10 in step S23, stop the transmission of the autonomous exit instruction signal in step S25 if the rotation swiping operation is stopped in step S24. and again continuously transmit the autonomous exit instruction signal to the vehicle 10 in step S27 if the rotation swiping operation is restarted in S26. That is, the autonomous exit stop instruction signal may not be used.

### Processing on Vehicle 10 During Autonomous Exit

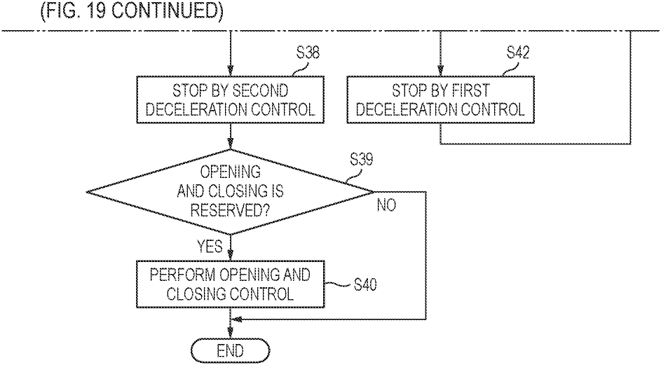

Next, an example of the exit execution control performed by the autonomous parking control unit 55 of the vehicle 10 during the autonomous exit will be described with reference to a flowchart of FIG. 19.

The autonomous parking control unit 55 of the vehicle 10 determines whether the communication with the information terminal 60 is connected, that is, whether the information terminal 60 is in a state of approaching a distance at which the wireless communication with the vehicle 10 is available (step S31).

In step S31, if the vehicle is not connected to the information terminal 60 for communication (step S31: No), the autonomous parking control unit 55 waits until the communication connection is established.

In step S31, if the communication with the information terminal 60 is connected (step S31: Yes), the autonomous parking control unit 55 receives, from the information terminal 60, the autonomous exit information related to the exit direction and the reserved opening and closing body of the vehicle 10 which are received by the information terminal 60 (step S32).

Next, the autonomous parking control unit 55 specifies a relative position between the host vehicle 10 and the information terminal 60 by performing the UWB communication with the information terminal 60 (step S33).

Next, based on the position of the information terminal 60 specified in step S33, the autonomous parking control unit 55 sets the target movement position to a position near the information terminal 60, that is, sets the target movement position of the vehicle 10 such that the position of the driver seat is near the information terminal 60 (user M carrying the information terminal 60) when the vehicle 10 moves to the target movement position (step S34).

Next, the autonomous parking control unit 55 determines whether the autonomous exit start instruction signal is received from the information terminal 60. that is, whether the autonomous exit start instruction signal transmitted from the information terminal 60 in the processing of step S23 in the information terminal 60 of FIG. 7 is received (step S35).

In step S35, if the autonomous exit start instruction signal is not received from the information terminal 60 (step S35: No), the autonomous parking control unit 55 waits until the autonomous exit start instruction signal is received.

In step S35, if the autonomous exit start instruction signal is received from the information terminal 60 (step S35: Yes), the autonomous parking control unit 55 causes the vehicle 10 to move to the target movement position set in step S34 (step S36).

Next, the autonomous parking control unit 55 determines whether the vehicle 10 approaches the target movement position (step S37).

In step S37, if the target movement position is approached (step S37: Yes), the autonomous parking control unit 55 causes the vehicle 10 to stop due to the deceleration of the second deceleration control (step S38). The deceleration of the second deceleration control, as described above, is deceleration set to be smaller than the deceleration of the first deceleration control, and is deceleration control that requires a longer time to stop than the first deceleration control, but can stop the vehicle 10 more smoothly than the first deceleration control. The matter that the vehicle 10 approaches the target movement position means that when the vehicle 10 is stopped due to the deceleration of the second deceleration control, the vehicle 10 reaches an approaching distance at which the vehicle 10 just stops at the target movement position. Accordingly, the vehicle 10 stops at the position where the driver seat is near the user M carrying the information terminal 60.

Next, when the vehicle 10 stops at the target movement position, the autonomous parking control unit 55 determines whether the opening and closing of the door of the vehicle 10 is reserved based on the autonomous exit information received from the information terminal 60 in step S32 (step S39).

In step S39, if the opening and closing of the door is reserved (step S39: Yes), the autonomous parking control unit 55 opens and closes the door reserved for the opening and closing under the opening and closing control performed by the opening and closing control unit 56 (step S40), and the exit execution control is ended. As described above, the opening and closing of the door includes unlocking the door, autonomously opening and closing the door, and the like.

In step S39, if the opening and closing of the door is not reserved (step S39: No), the autonomous parking control unit 55 does not perform the opening and closing, and the exit execution control is ended.

On the other hand, in step S37, if the target movement position is not approached (step S37: No), the autonomous parking control unit 55 determines whether the autonomous exit stop instruction signal is received from the information terminal 60, that is, whether the autonomous exit stop instruction signal transmitted from the information terminal 60 in the processing of step S25 in the information terminal 60 of FIG. 7 is received (step S41).

In step S41, if the autonomous exit stop instruction signal is not received from the information terminal 60 (step S41: No), the autonomous parking control unit 55 returns to step S37 and executes the processing.

In step S41. if the autonomous exit stop instruction signal is received from the information terminal 60 (step S41: Yes), the autonomous parking control unit 55 causes the vehicle 10 to stop due to the deceleration of the first deceleration control (step S42). A case where the autonomous exit stop instruction signal is received from the information terminal 60 is a case where the rotation swiping operation of the user M on the information terminal 60 is stopped, as described above. The deceleration of the first deceleration control, as described above, is deceleration set to be larger than the deceleration of the second deceleration control, and is deceleration control capable of stopping the vehicle 10 in a shorter time than the second deceleration control. Accordingly, the vehicle 10 temporarily stops before reaching the target movement position.

Even when the vehicle 10 is approaching the target movement position and decelerating under the second deceleration control, if the autonomous exit stop instruction signal is received from the information terminal 60, the autonomous parking control unit 55 causes the vehicle 10 to stop due to the deceleration of the first deceleration control.

In the above processing, the autonomous parking control unit 55 starts the movement to the target movement position in step S36 if the autonomous exit start instruction signal is received from the information terminal 60 in step S35, and causes the vehicle to stop due to the deceleration of the first deceleration control in step S42 if the autonomous exit stop instruction signal is received from the information terminal 60 in step S41, but the present disclosure is not limited thereto. For example, when the autonomous exit instruction signal is continuously transmitted from the information terminal 60, the autonomous parking control unit 55 may start the movement to the target movement position in step S36 if the autonomous exit instruction signal is received from the information terminal 60 in step S35, and may cause the vehicle 10 to stop due to the deceleration of the first deceleration control in step S42 if the autonomous exit instruction signal from the information terminal 60 in step S41 is stopped.

### Example of Movement to Target Movement Position

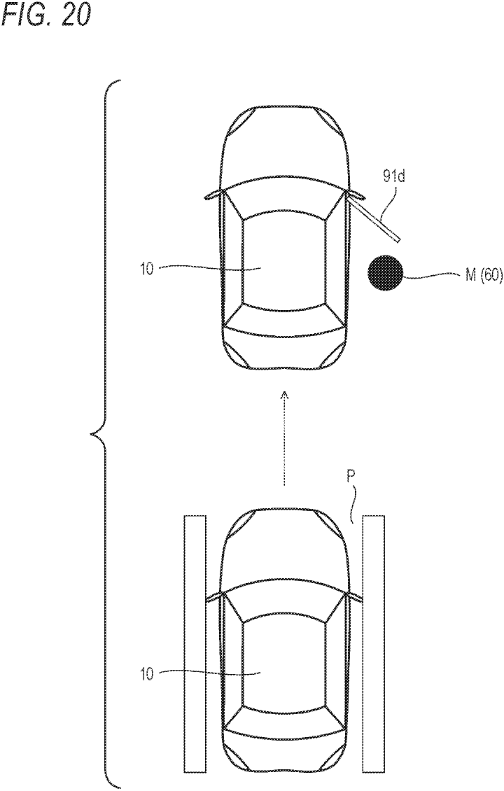

Next, an example of the movement of the vehicle 10 that moves to the target movement position by the exit execution control will be described with reference to FIG. 20.

FIG. 20 is a diagram showing an example of a state where the vehicle 10 parked in the parking space P moves to a location (target movement position) where the user M who performs an autonomous exit operation by using the information terminal 60 is present. As shown in FIG. 20. the vehicle 10 is controlled to exit so as to move to and stop at a position where the right front driver seat comes close to the user M carrying the information terminal 60. In the example shown in FIG. 20, a right front door 91d, which is the door of the driver seat, is reserved for opening and closing, and after the vehicle 10 moves to and stops at the target movement position, the opening and closing control is performed to open the right front door 91d.

### Deceleration Characteristics and Vehicle Speed Characteristics of Deceleration Control

Next, examples of deceleration characteristics and examples of vehicle speed characteristics of the first deceleration control and the second deceleration control performed by the autonomous parking control unit 55 will be described with reference to FIGS. 21 and 22.

FIG. 21 is a diagram showing the example of the deceleration characteristics and the vehicle speed characteristics of the first deceleration control performed by the autonomous parking control unit 55. The first deceleration control is, as described above, deceleration control that is executed when the autonomous exit stop instruction signal is received from the information terminal 60 or when the autonomous exit instruction signal from the information terminal 60 is stopped. In other words, the first deceleration control is deceleration control executed when the rotation swiping operation of the user M on the information terminal 60 is interrupted.

As shown in FIG. 21, according to deceleration characteristics 92 of the first deceleration control, if the rotation swiping operation is interrupted at a timing t1, for example, the brake pedal of the vehicle 10 is depressed from the timing t1. and the deceleration increases to G1, for example. In this case, according to vehicle speed characteristics 93 of the first deceleration control, the deceleration starts at the timing t1 when the brake pedal is depressed, and a vehicle speed V1 decreases. The first deceleration control is a control that does not reduce a deceleration value increased to G1 from the timing t1 when the vehicle 10 starts decelerating to a timing t2 when the vehicle 10 stops and the vehicle speed becomes 0. In the first deceleration control, the vehicle 10 stops at the timing t2 after a time T1 from the timing t1 when the rotation swiping operation of the user M is interrupted.

FIG. 22 is a diagram showing the example of the deceleration characteristics and the vehicle speed characteristics of the second deceleration control performed by the autonomous parking control unit 55. The second deceleration control is, as described above, deceleration control that is executed when the vehicle 10 approaches the target movement position during the autonomous exit.

As shown in FIG. 22. according to deceleration characteristics 94 of the second deceleration control, assuming that the vehicle 10 approaches the target movement position at, for example, a timing t3, the brake pedal of the vehicle 10 is depressed at the timing t3, and the deceleration increases to G2, for example. In this case, according to vehicle speed characteristics 95 of the second deceleration control, the deceleration starts at the timing t3 when the brake pedal is depressed, and the vehicle speed V1 decreases. The second deceleration control is a control that reduces a deceleration value increased to G2 to deceleration G3 that is smaller than the deceleration G2 during a period from the timing t3 when the vehicle 10 starts decelerating to a timing t4 when the vehicle 10 stops and the vehicle speed becomes 0. In the second deceleration control, the vehicle 10 stops at the timing t4 after a time T2 from the timing t3 when the brake pedal is depressed. The timing t3 at which the target movement position is approached is a deceleration start point for causing the vehicle 10 to stop at the target movement position in the second deceleration control.

As described above, when performing the exit execution control on the vehicle 10, the autonomous parking control unit 55 in the calculation unit 52 of the vehicle 10 can perform the first deceleration control on the vehicle 10 in response to interruption of the rotation swiping operation (specific operation) of the user M on the information terminal 60, and the second deceleration control on the vehicle 10 in response to approaching the target movement position of the exit execution control. The autonomous parking control unit 55 sets the deceleration of the second deceleration control to be smaller than the deceleration of the first deceleration control. Accordingly, the autonomous exit of the vehicle 10 is controlled by the first deceleration control with a larger deceleration than the second deceleration control. so that the vehicle 10 can be decelerated immediately at a timing when the user M interrupts continuation of the rotation swiping operation. Therefore, for example, it is possible to perform the deceleration with a good response to run out of a pedestrian or in accordance with the rotation swiping operation of the user M, and it is possible to improve safety and marketability. The vehicle 10 is controlled by the second deceleration control with small deceleration, so that it is possible to prevent a situation or damage that the user M near the vehicle 10 and the vehicle 10 come into contact with each other when the vehicle 10 approaches the target movement position. By decelerating with the second deceleration control, there is no sudden stop due to large deceleration like the first deceleration control, and thus, for example, it is possible to improve the marketability of the approaching behavior of the vehicle 10 when the vehicle 10 picks up the user M, and to reduce anxiety of collision of the vehicle 10 to improve a sense of security.

The autonomous parking control unit 55 can change the deceleration of the second deceleration control based on the state of the user M of the vehicle 10. and thus, for example, when the user M is in a hurry based on the schedule information, it is possible to set the deceleration to a large value, and immediately decelerate the vehicle 10 during the autonomous exit. Accordingly, the deceleration control in consideration of the state of user M can be performed, and usability can be improved.

The autonomous parking control unit 55 can change the deceleration of the second deceleration control based on the external environment of the vehicle 10. and thus, for example, when the weather is bad, it is possible to set the deceleration to a large value and quickly pick up the user during the autonomous exit. Accordingly, the deceleration control can be performed in consideration of the external environment, and the usability can be improved.

The autonomous parking control unit 55 controls not to reduce the deceleration of the vehicle 10 until the vehicle 10 stops in the first deceleration control, and controls to reduce the deceleration of the vehicle 10 until the vehicle 10 stops in the second deceleration control. Accordingly, the vehicle 10 can be stopped in a shorter time in the first deceleration control than in the second deceleration control, and the vehicle 10 can be stopped more smoothly in the second deceleration control than in the first deceleration control.

The autonomous parking control unit 55 changes the deceleration characteristics of the second deceleration control based on the setting of the user M. Depending on the user M, there may be a case in which the user M prefers to be picked up quickly during the autonomous exit, and thus, it is possible to satisfy a request of the user M.

The autonomous parking control unit 55 changes the deceleration characteristics of the second deceleration control based on the driving history of the user M. Accordingly, for example, it is possible to set the deceleration characteristics similar to the deceleration characteristics that the user M performs when driving, and thus, it is possible to pick up the user M in a way of matching preference of the user M.

The autonomous parking control unit 55 sets the target movement position of the vehicle 10 during the autonomous exit based on the position of the information terminal 60. Accordingly, the target movement position is autonomously set even if the user M does not manually set the target movement position of the exit execution control, and thus, an operation burden on the user M can be reduced, and the usability can be improved. In the control of the autonomous parking control unit 55 described above, the target movement position is set based on the positional relationship between the driver seat of the vehicle 10 and the information terminal 60, but the present disclosure is not limited thereto. For example, the target movement position may be set in consideration of whether a door (opening and closing body) of the vehicle 10 is opened or closed. Specifically, the target movement position may be set based on the positional relationship between the information terminal 60 and the door of the vehicle 10 that is reserved for opening and closing. In this case, a position where the user M can easily access the door reserved for opening and closing is set as the target movement position.

The autonomous parking control unit 55 specifies the position of the information terminal 60 with respect to the vehicle 10 based on ultra wide band communication with the information terminal 60. Accordingly, the position of the information terminal 60 can be specified with high accuracy, and thus, it is possible to set an optimum target movement position of the vehicle 10 where the user M can easily access the opening and closing body.

Although the embodiment of the present disclosure has been described, the present disclosure is not limited to the above embodiment, and modifications, improvements, and the like can be made as appropriate.

For example, in the above embodiment, an example in which the moving object is a vehicle (four-wheeled automobile) has been described, but the present disclosure is not limited thereto. For example, the moving object may be a two-wheeled vehicle or a Segway. Further, the concept of the present disclosure can be applied not only to a vehicle but also to a robot, a ship, an aircraft, or the like that is provided with a drive source and is movable according to power of the drive source.

The control method described in the above embodiment can be implemented by executing a control program prepared in advance on a computer. The control program is recorded in a computer-readable storage medium and is executed by being read from the storage medium. In addition, the control program may be provided in a form of being stored in a non-transitory storage medium such as a flash memory or may be provided via a network such as the Internet. The computer that executes the control program may be provided in a control device, may be provided in an electronic device such as a smartphone, a tablet terminal, or a personal computer capable of communicating with the control device or may be provided in a server device capable of communicating with the control device and the electronic device.

In addition, at least the following matters are described in the present specification. Although corresponding components or the like in the above embodiment are shown in parentheses, the present disclosure is not limited thereto.

(1) A control device (calculation unit 52) of a moving object (vehicle 10), the control device including:
a controller (autonomous parking control unit 55) configured to control movement of the moving object based on a specific operation performed on a portable information terminal (information terminal 60) for a user (user M) of the moving object, in which
the controller is configured to:
   when executing the movement control, perform first deceleration control on the moving object in response to interruption of the specific operation, and second deceleration control on the moving object in response to approaching a target movement position of the movement control, and
   set deceleration of the second deceleration control to be smaller than deceleration of the first deceleration control.

According to (1), the moving object is controlled by the first deceleration control with the large deceleration, so that it is possible to immediately decelerate at a timing when the user interrupts continuation of the specific operation. Therefore, for example, it is possible to perform the deceleration with a good response to run out of a pedestrian or in accordance with the specific operation of the user, and safety and marketability are improved. The moving object is controlled by the second deceleration control with the small deceleration, so that contact with and damage to the nearby user when the moving object approaches the target movement position can be prevented. By decelerating with the second deceleration control, unlike the first deceleration control, the moving object does not suddenly stop with the large deceleration, and thus, it is possible to improve marketability of a behavior at a time of picking up the user, and to reduce anxiety of collision to improve a sense of security.

(2) The control device according to (1), in which

the controller is configured to change the deceleration of the second deceleration control based on a state of the user of the moving object.

According to (2), for example, when the user is in a hurry due to being late or the like, the deceleration can be increased to cause the moving object to decelerate immediately. and the usability is improved by performing the deceleration control in consideration of a state of the user.

(3) The control device according to (1) or (2), in which

the controller is configured to change the deceleration of the second deceleration control based on an external environment of the moving object.

According to (3), for example, when the weather is bad, it is possible to quickly pick up the user by increasing the deceleration, and the usability is improved by performing the deceleration control in consideration of the external environment.

(4) The control device according to any one of (1) to (3), in which

the controller is configured to set the target movement position based on a position of the information terminal.

According to (4), since the target movement position is autonomously set even if the user does not manually set the target movement position for the movement control, a burden on the user is reduced, and the usability is improved. Furthermore, the target movement position may be set in consideration of whether the opening and closing body is opened or closed.

(5) The control device according to (4), in which

the controller is configured to specifie the position of the information terminal based on ultra wide band communication with the information terminal.

According to (5), the position of the information terminal can be specified with high accuracy, and it is possible to set an optimum target movement position.

(6) The control device according to any one of (1) to (5). in which
the first deceleration control is control that does not reduce deceleration of the moving object until the moving object stops, and
the second deceleration control is control that reduces the deceleration of the moving object until the moving object stops.

According to (6), the first deceleration control can cause the moving object to stop in a shorter time, and the second deceleration control can cause the moving object to stop more smoothly.

(7) The control device according to any one of (1) to (6), in which

the second deceleration control is control for decelerating the moving object according to deceleration characteristics set by the user.

According to (7), depending on the user M, there may be cases where the user prefers to be picked up more quickly, and thus, the user can set the deceleration characteristic within a deceleration range smaller than that of the first deceleration control.

(8) The control device according to any one of (1) to (7), in which

the second deceleration control is control for decelerating the moving object according to deceleration characteristics based on a driving history of the user of the moving object

According to (8), for example, the deceleration characteristics similar to the deceleration characteristics that the user performs when driving are set, so that it is possible to pick up the user M in a way of matching preference of the user M.

(9) A control method performed by a controller, in which
the controller is configured to control movement of a moving object based on a specific operation performed on a portable information terminal for a user of the moving object, and
the control method includes:
   when executing the movement control, performing first deceleration control on the moving object in response to interruption of the specific operation, and second deceleration control on the moving object in response to approaching a target movement position of the movement control, and
   setting deceleration of the second deceleration control to be smaller than deceleration of the first deceleration control.

According to (9), the moving object is controlled by the first deceleration control with the large deceleration, so that it is possible to immediately decelerate at a timing when the user interrupts continuation of the specific operation. Therefore, for example, it is possible to perform the deceleration with a good response to run out of a pedestrian or in accordance with the specific operation of the user, and safety and marketability are improved. The moving object is controlled by the second deceleration control with the small deceleration, so that contact with and damage to the nearby user when the moving object approaches the target movement position can be prevented. By decelerating with the second deceleration control, unlike the first deceleration control, the moving object does not suddenly stop with the large deceleration, and thus, it is possible to improve marketability of a behavior at a time of picking up the user, and to reduce anxiety of collision to improve a sense of security.

(10) A non-transitory computer-readable recording medium storing a control program for causing a processor to execute processing, in which
the processor is configured to control movement of a moving object based on a specific operation performed on a portable information terminal for a user of the moving object, and
the processing includes:
   when executing the movement control, performing first deceleration control on the moving object in response to interruption of the specific operation, and second deceleration control on the moving object in response to approaching a target movement position of the movement control, and
   setting deceleration of the second deceleration control to be smaller than deceleration of the first deceleration control.

According to (10), the moving object is controlled by the first deceleration control with the large deceleration, so that it is possible to immediately decelerate at a timing when the user interrupts continuation of the specific operation. Therefore, for example, it is possible to perform the deceleration with a good response to run out of a pedestrian or in accordance with the specific operation of the user, and safety and marketability are improved. The moving object is controlled by the second deceleration control with the small deceleration, so that contact with and damage to the nearby user when the moving object approaches the target movement position can be prevented. By decelerating with the second deceleration control, unlike the first deceleration control, the moving object does not suddenly stop with the large deceleration, and thus, it is possible to improve marketability of a behavior at a time of picking up the user, and to reduce anxiety of collision to improve a sense of security.

1. A control device of a moving object, the control device comprising:
a controller configured to control movement of a moving object based on a specific operation performed on a portable information terminal for a user of the moving object, wherein
the controller is configured to:
when executing the movement control, perform first deceleration control on the moving object in response to interruption of the specific operation, and second deceleration control on the moving object in response to approaching a target movement position of the movement control, and
set deceleration of the second deceleration control to be smaller than deceleration of the first deceleration control.

2. The control device according to claim 1, wherein
the controller is configured to change the deceleration of the second deceleration control based on a state of the user of the moving object.

3. The control device according to claim 1, wherein
the controller is configured to change the deceleration of the second deceleration control based on an external environment of the moving object.

4. The control device according to claim 1, wherein
the controller is configured to set the target movement position based on a position of the information terminal.

5. The control device according to claim 4, wherein
the controller is configured to specify the position of the information terminal based on ultra wide band communication with the information terminal.

6. The control device according to claim 1, wherein
the first deceleration control is control that does not reduce deceleration of the moving object until the moving object stops, and
the second deceleration control is control that reduces the deceleration of the moving object until the moving object stops.

7. The control device according to claim 1, wherein
the second deceleration control is control for decelerating the moving object according to deceleration characteristics set by the user.

8. The control device according to claim 1, wherein
the second deceleration control is control for decelerating the moving object according to deceleration characteristics based on a driving history of the user of the moving object.

9. A control method performed by a controller, wherein
the controller is configured to control movement of a moving object based on a specific operation performed on a portable information terminal for a user of the moving object, and
the control method comprises:
when executing the movement control, performing first deceleration control on the moving object in response to interruption of the specific operation, and second deceleration control on the moving object in response to approaching a target movement position of the movement control; and
setting deceleration of the second deceleration control to be smaller than deceleration of the first deceleration control.

10. A non-transitory computer-readable recording medium storing a control program for causing a processor to execute processing, wherein
the processor is configured to control movement of a moving object based on a specific operation performed on a portable information terminal for a user of the moving object, and
the processing comprises:
when executing the movement control, performing first deceleration control on the moving object in response to interruption of the specific operation, and second deceleration control on the moving object in response to approaching a target movement position of the movement control, and
setting deceleration of the second deceleration control to be smaller than deceleration of the first deceleration control.
